(19) United States
(12) Patent Application Publication
(10) Pub. No.: US 2013/0316254 A1
(43) Pub. Date: Nov. 28, 2013

(54) ENERGY SYSTEM

(71) Applicants: Kenichi Tokuhiro, Osaka (JP); Takaiki Nomura, Osaka (JP); Takahiro Suzuki, Osaka (JP); Satoru Tamura, Osaka (JP); Nobuhiro Miyata, Osaka (JP); Noboru Taniguchi, Osaka (JP); Kazuhito Hato, Osaka (JP)

(72) Inventors: Kenichi Tokuhiro, Osaka (JP); Takaiki Nomura, Osaka (JP); Takahiro Suzuki, Osaka (JP); Satoru Tamura, Osaka (JP); Nobuhiro Miyata, Osaka (JP); Noboru Taniguchi, Osaka (JP); Kazuhito Hato, Osaka (JP)

(73) Assignee: PANASONIC CORPORATION, Kadoma-shi, Osaka (JP)

(21) Appl. No.: 13/984,413

(22) PCT Filed: Feb. 29, 2012
(86) PCT No.: PCT/JP2012/001372

§ 371 Date: Aug. 8, 2013

(30) Foreign Application Priority Data
Mar. 8, 2011 (JP) 2011-049808

(51) Int. Cl. H01M 8/04; H01M 8/06

(52) U.S. Cl. CPC H01M 8/04119; H01M 8/0656
USPC 429/410; 429/414

(57) ABSTRACT

An energy system includes an solar hydrogen producing unit (101) that produces hydrogen through decomposition of water by a photocatalytic effect, a fuel cell (103) that generates electricity by a reaction between the hydrogen produced by the solar hydrogen producing unit (101) and an oxidizing gas and discharges water as a reaction product, and a water distribution mechanism (104) that returns the water serving as the reaction product discharged from the fuel cell (103) to the solar hydrogen producing unit (101). With the configuration, an energy system that suppresses an amount of external water supply to a low level to achieve good water balance can be provided.

### TECHNICAL FIELD

The present invention relates to an energy system including a hydrogen producing unit that produces hydrogen through decomposition of water by at least a photocatalytic effect and a fuel cell that produces electricity by using hydrogen as an energy source.

### BACKGROUND ART

In terms of reduction in carbon dioxide emission or anti-pollution energy, hydrogen energy attracts attention. Hydrogen is used as an energy medium for a fuel cell or the like to make it possible to convert the hydrogen into electricity or heat and to use the hydrogen as heat or motive energy by directly burning the hydrogen itself. In any of the cases where hydrogen is used in a fuel cell and where hydrogen is directly burned, innoxious, safe water is produced as a final product, so that an anti-pollusition energy cycle can be created.

Although hydrogen is a naturally occurring substance, most of hydrogen is produced from petroleum or natural gas by cracking using a catalyst. Although hydrogen and oxygen can also be produced by the electrolysis of water, electric energy for electrolysis is required, and hydrogen cannot be said to be clean energy because of use of general electric power.

A system that converts solar energy into electricity with a solar battery and electrolyzes water with the electric power is also conceived. However, in consideration of the manufacturing cost, the energy consumption, and the electric accumulation technique of a solar battery, a method of producing hydrogen using such a system is not an exactly effective method.

In contrast to this, production of hydrogen through decomposition of water using a semiconductive photocatalyst is a method of directly producing hydrogen from water or sunlight, and can effectively convert sunlight energy into hydrogen energy.

Conventionally, some devices to produce hydrogen using semiconductive photocatalysts and some configurations of hydrogen production system using the devices have been proposed.

Patent Literature 1 discloses means that circulates an electrolyte decomposed with a photocatalyst and compensates for water reduced through decomposition with the photocatalyst from the outside of the system.

However, in the hydrogen generation system disclosed in Patent Literature 1, a mechanism for introducing clean water or the like corresponding to a reducing electrolyte from the outside is employed, and, for this purpose, a mechanism for supplying water from the outside of the system is required.

### CITATION LIST

### Patent Literature

PTL 1: Unexamined Japanese Patent Publication No. S57-191202

### SUMMARY OF THE INVENTION

The present invention is made to solve the above conventional problems, and an object thereof is to provide a good-water-balance energy system that suppresses an amount of external water supply to a low level.

There is provided an energy system including: a hydrogen producing unit that produces hydrogen through decomposition of water by a photocatalytic effect; a fuel cell that generates electricity by a reaction between the hydrogen generated by the hydrogen producing unit and an oxidizing gas, and discharges water as a reaction product; and a water distribution mechanism for returning the water that is the reaction product discharged from the fuel cell to the hydrogen producing unit.

The energy system according to the present invention can cause the fuel cell to generate electricity by using hydrogen produced through decomposition of water in the hydrogen producing unit and external oxygen. Furthermore, water produced by generation of electricity in the fuel cell is collected and returned to the hydrogen producing unit by the water distribution mechanism to make it possible to cause the hydrogen producing unit to produce hydrogen again by using the water produced by the fuel cell. Thus, the energy system can be operated while suppressing an amount of external water supply to a low level.

### BRIEF DESCRIPTION OF DRAWINGS

FIG. 1A is a diagram showing a configuration example of an energy system in an embodiment of the present invention.

FIG. 1B is a diagram showing another configuration example of an energy system in an embodiment of the present invention.

FIG. 2 is a schematic configuration diagram of a hydrogen producing unit in the embodiment of the present invention.

FIG. 3 is a diagram showing a modification of an energy system in the embodiment of the present invention.

FIG. 4 is a diagram showing a modification of an energy system in the embodiment of the present invention.

FIG. 5A is a diagram showing a modification of the energy system in the embodiment of the present invention.

FIG. 5B is a diagram showing a modification of the energy system in the embodiment of the present invention.

FIG. 6 is a diagram showing a modification of the energy system in the embodiment of the present invention.

### DESCRIPTION OF EMBODIMENT

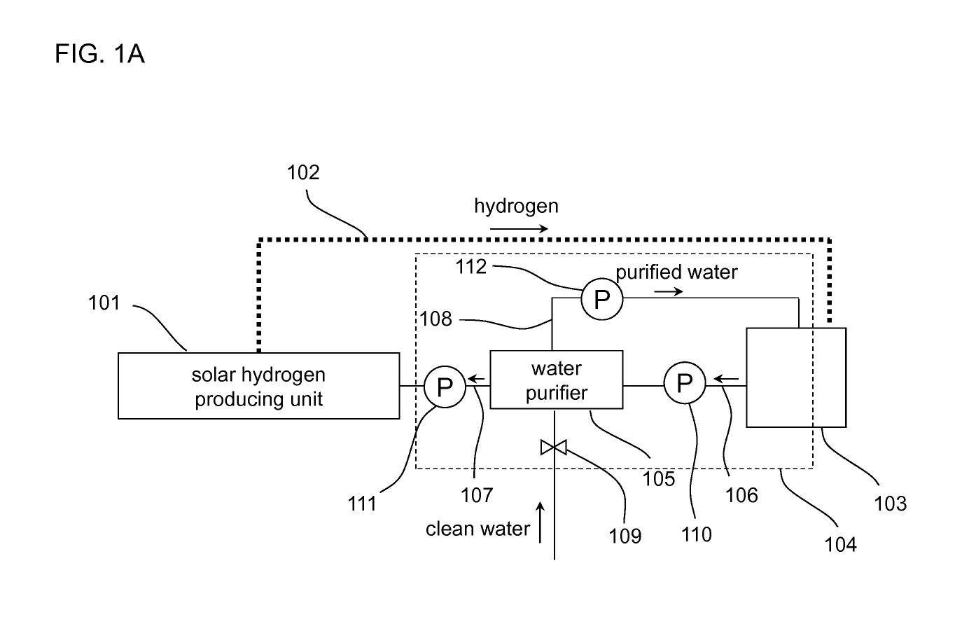

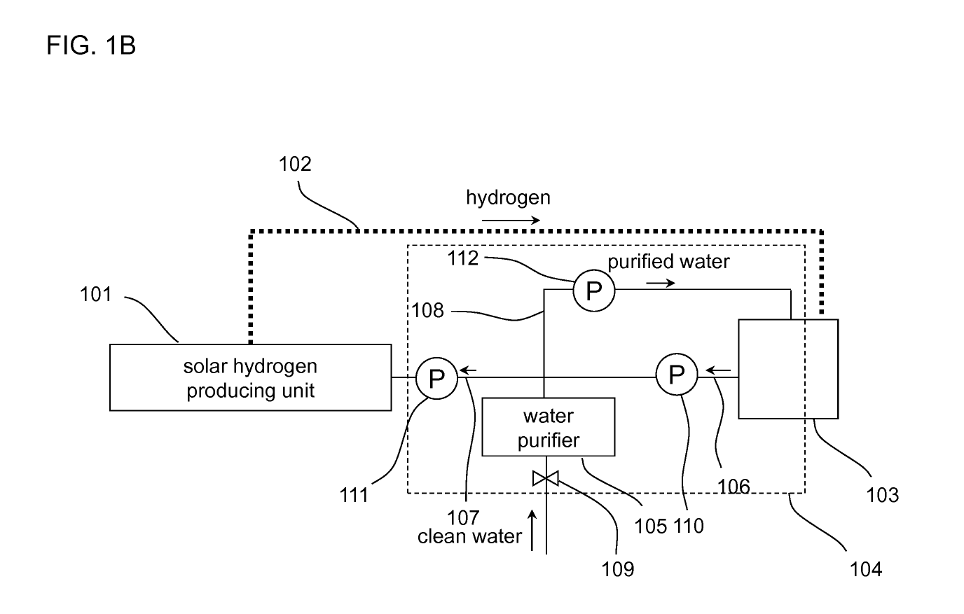

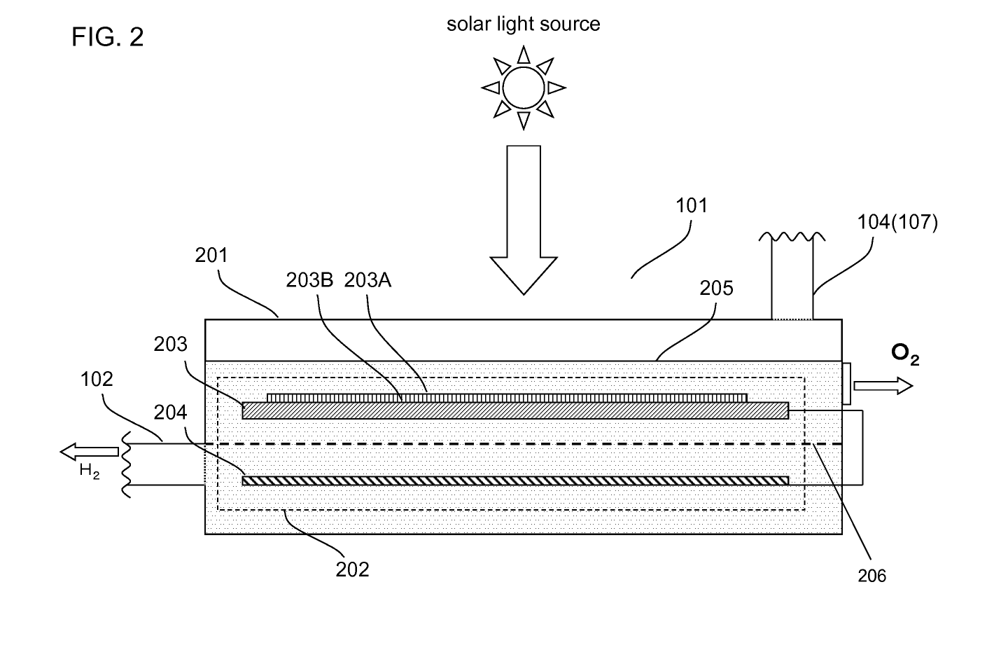

An embodiment of the present invention will be described below with reference to FIG. 1A and FIG. 2. The following embodiment is just an example, and the present invention is not limited to the following embodiment.

FIG. 1A is a diagram showing a configuration example of an energy system in the embodiment of the present invention. FIG. 2 is a schematic configuration diagram of a solar hydrogen producing unit in the embodiment of the present invention. The energy system includes solar hydrogen producing unit 101, fuel cell 103, hydrogen distribution mechanism 102, and water distribution mechanism 104. Solar hydrogen producing unit 101 produces hydrogen through decomposition of an electrolyte such as water by irradiation with light. Fuel cell 103 generates electricity by using hydrogen and an oxidizing gas such as oxygen as an energy source. Hydrogen distribution mechanism 102 supplies hydrogen produced in solar hydrogen producing unit 101 to fuel cell 103. Water distribution mechanism 104 returns water that is a reaction product discharged from fuel cell 103 to solar hydrogen producing unit 101.

As shown in FIG. 2, solar hydrogen producing unit 101 includes housing 201 and electrode unit 202. Housing 201 has a substantially box-like shape. At least a part of housing 201 is made of a material such as quartz glass that transmits at least visible light. Electrolyte 205 is retained in housing 201. Electrolyte 205 contains at least water. Electrolyte 205 may further contain, as needed, an electrolyte, oxidizing/reducing material, and/or a sacrificial reagent. Hydrogen distribution mechanism 102 for distributing hydrogen produced in housing 201 to fuel cell 103 is connected to housing 201. Water distribution mechanism 104 for distributing an electrolyte from the outside of solar hydrogen producing unit 101 into housing 201 is connected to housing 201.

Electrode unit 202 produces hydrogen and oxygen through decomposition of water. Electrode unit 202 has first electrode 203 serving as a photocatalytic semiconductor electrode and second electrode 204 serving as a counter electrode.

First electrode 203 includes conductive substrate 203A and photocatalytic semiconductor layer 203B formed on a conductive surface of conductive substrate 203A and having a photocatalytic function. Conductive substrate 203A may be made of a metal foil or a metal plate or may be configured such that a conductive film such as ITO or FTO is formed on a surface of a non⁻conductive substrate such as glass. First electrode 203 is arranged such that at least photocatalytic semiconductor layer 203B is dipped in electrolyte 205 in housing 201. First electrode 203 is arranged such that photocatalytic semiconductor layer 203B is irradiated with light in housing 201.

Photocatalytic semiconductor layer 203B is made of various semiconductor materials in which excited electrons and positive holes are formed by irradiation with ultraviolet radiation or visible light of sunlight or the like. As the semiconductor materials, oxides such as titanium oxide or tungstic oxide, oxide solid solutions, oxynitrides, and the like are mainly used. Photocatalytic semiconductor layer 203B is not necessarily made of a single material, and may be made of a plurality of semiconductor materials. Photocatalytic semiconductor layer 203B may contain, in addition to the semeiconductor material, a promoter made of platinum or the like, a sensitizing dye that enhances light absorption, and the like. Although solar hydrogen producing unit 101 in the embodiment is configured to have one first electrode 203 including photocatalytic semiconductor layer 203B, solar hydrogen producing unit 101 is not limited to the configuration and may have two or more first electrodes 203 that may have photocatalytic semiconductor layers 203B of different types.

Second electrode 204 is arranged at a position where second electrode 204 does not prevent irradiation of sunlight on photocatalytic semiconductor layer 203B in housing 201. First electrode 203 and second electrode 204 are electrically connected to each other. Second electrode 204 is made of a material that can be used as a counter electrode, and, for example, a metal such as platinum, nickel, cobalt, or titanium, carbon, or the like can be used. An electrode obtained by depositing the metal thin film on the surface of a metal plate such as a titanium plate or conductive glass may be used. As the shape of second electrode 204, various shapes can be applied. Depending on conditions, shapes such as a rod-like shape, a plate-like shape, and a net-like shape can be arbitrarily selected.

As shown in FIG. 2, housing 201 is preferably configured such that hydrogen and oxygen generated inside housing 201 are outward discharged without being mixed with each other. More specifically, the following configuration is preferably used. The interior of housing 201 is divided into at least two chambers. First electrode 203 and second electrode 204 are arranged in the chambers, respectively. In order to divide the interior into the two chambers, for example, an ion-exchange membrane 206 that can transmit, for example, only an ionic material is used. Each of the chambers is provided with a gas discharging port that can be connected to the outside.

Fuel cell 103 shown in FIG. 1A may be of any of a solid polymer type and a solid electrolyte type. Fuel cell 103 includes an anode chamber into which hydrogen is introduced and a cathode chamber into which a gas containing an oxidizing gas is introduced. Hydrogen distribution mechanism 102 communicates with an anode chamber inlet port of fuel cell 103.

Although hydrogen distribution mechanism 102 is not limited to a specific hydrogen distribution mechanism as long as the mechanism can distribute hydrogen, for example, hydrogen distribution mechanism 102 may be configured by a metal pipe. A pump to move a material to be distributed is preferably arranged on a path. The mechanism may be configured to be arbitrarily provided with a storage tank or the like on the path of the pipe.

Water distribution mechanism 104 includes water purifier 105, first path 106, second path 107, third path 108, and water supply unit 109.

Water purifier 105 is connected to an outlet of the cathode chamber of fuel cell 103 with first path 106. Water purifier 105 purifies water discharged from fuel cell 103.

Water purifier 105 is connected to housing 201 of solar hydrogen producing unit 101 with second path 107. The water purified by water purifier 105 is sent into housing 201 through second path 107.

Water purifier 105 is connected to fuel cell 103 with third path 108. The water purified by water purifier 105 is sent into fuel cell 103 through third path 108.

Clean water (for example, city water) is directly or indirectly supplied from water supply unit 109 to water purifier 105. The supplied clean water and the water discharged from fuel cell 103 are purified by water purifier 105.

First path 106, second path 107, and third path 108 are configured by, for example, metal pipes, respectively.

First path 106, second path 107, and third path 108 are provided with first pump 110, second pump 111, and third pump 112, respectively. First pump 110, second pump 111, and third pump 112 are controlled by a control unit (not shown), and pressure fluids flowing in the paths as needed to send the fluids.

Water purifier 105 is not limited to a specific water purifier as long as the water purifier is a general water purifier. However, water is preferably purified by, especially, a scheme using an ion exchange resin, a scheme using an electrode applied with a bias, or the like.

An operation of the energy system in the embodiment will be described below. An operational principle of solar hydrogen producing unit 101 in the embodiment will now be described. As shown in FIG. 2, when photocatalytic semiconductor layer 203B of first electrode 203 is irradiated with sunlight through the portion that transmits at least visible light in housing 201, excited electrons (e−) and positive holes (h+) are produced on photocatalytic semiconductor layer 203B.

For example, when photocatalytic semiconductor layer 203B is made of an n-type semiconductor material, the produced positive holes decompose water and produce oxygen on the surface of photocatalytic semiconductor layer 203B with a chemical reaction expressed by reaction formula (1). On the other hand, the produced excited electrons move from photocatalytic semiconductor layer 203B to conductive substrate 203A and move from conductive substrate 203A to second electrode 204. Water is decomposed and hydrogen is produced on second electrode 204 with a chemical reaction expressed by reaction formula (2).

[Chemical formula 1]

4h⁺+2H₂O→O₂↑+4H⁺ (1)

[Chemical formula 2]

4e⁻+4H⁺→2H₂↑ (2)

Produced hydrogen and oxygen are introduced to the outside of housing 201 without being mixed with each other in housing 201. In particular, hydrogen is sent to the anode chamber of fuel cell 103 through hydrogen distribution mechanism 102.

An operational principle of fuel cell 103 will be described below. Fuel cell 103, as described above, includes an anode chamber into which hydrogen is introduced and a cathode chamber into which a gas containing an oxidizing gas is introduced.

The hydrogen introduced into fuel cell 103 causes a chemical reaction expressed by reaction formula (3) with an oxidizing gas to produce electric energy and water. Hydrogen used at this time is produced by solar hydrogen producing unit 101 and sent by hydrogen distribution mechanism 102.

[Chemical formula 3]

2H₂+O₂→2H₂O (3)

Water produced by a chemical reaction expressed by reaction formula (3) is discharged in the form of liquid or water vapor from the cathode chamber side of fuel cell 103 to the outside of fuel cell 103. Discharged moisture is collected by a water collecting unit (not shown) and sent to water purifier 105 through first path 106 that causes the cathode chamber of fuel cell 103 to communicate with water purifier 105. The water collecting unit may be arranged on an upstream side of water purifier 105, may be arranged on first path 106, or may be integrally formed together with fuel cell 103 and water purifier 105. At this time, a condenser or the like may be arranged to condense and transport water.

An operation in water distribution mechanism 104 will be described below. Water discharged from the cathode chamber side of fuel cell 103 is pressured by first pump 110 and sent to water purifier 105 through first path 106. Water purifier 105 remove impurities such as heavy metal ions and halogen ions contained in water sent through first path 106. The water the impurities of which are removed by water purifier 105 is pressured by second pump 111 and sent into housing 201 of solar hydrogen producing unit 101 through second path 107.

The water purified by water purifier 105 is compressed by third pump 112 and sent to fuel cell 103 through third path 108. The water sent to fuel cell 103 is used for cooling of a stack of fuel cell 103, humidification of an electrolyte film, and the like and collected by the water collecting unit.

Water supply unit 109 that supplies water such as clean water from the outside is directly or indirectly connected to water purifier 105. Water supply unit 109 supplies water to water purifier 105 as needed. The water supplied from water supply unit 109 is also purified by water purifier 105 like the water discharged from fuel cell 103. The purified water is sent to solar hydrogen producing unit 101 and fuel cell 103 through second path 107 and third path 108. Water supply unit 109 is connected to water purifier 105 in the embodiment. However, this configuration is not necessarily used, and water supply unit 109 may be connected to first path 106.

Water supply from water supply unit 109 will be described here in further detail. Water supply from water supply unit 109 is performed when an amount of water in the energy system is lower than a predetermined value. Various methods can be applied to detection of an amount of water in the energy system. For example, a sensor (not shown) that detects an amount of water based on a water level or a weight of water is arranged on solar hydrogen producing unit 101, or a sensor (not shown) that detects an amount of water passing through water distribution mechanism 104 is arranged on water distribution mechanism 104 to make it possible to estimate an amount of water that cannot be recycled to leak to the outside by comparison with quantity of electricity generated in fuel cell 103. When the sensor detects that the amount of water in the energy system is lower than a predetermined value, a control unit (not shown) opens a valve (not shown) that connects water supply unit 109 to clean water line (not shown). The clean water is supplied from water supply unit 109 to water purifier 105.

The water supply from water supply unit 109 can be automatically controlled by, for example, the following configuration.

A water level sensor that measures an internal water level is arranged in solar hydrogen producing unit 101. As the water level sensor, water level sensors of a float type, an ultrasonic type, an electric capacitance type, a pressure type, and the like can be used.

In solar hydrogen producing unit 101, in order to prevent hydrogen production efficiency from being deteriorated, first electrode 203 serving as a photocatalytic semiconductor electrode stored in solar hydrogen producing unit 101 and second electrode 204 serving as a counter electrode need to be entirely dipped in electrolyte 205. This is because, when first electrode 203 and second electrode 204 are partially exposed from electrolyte 205, an exposed portion that is not in contact with electrolyte 205 cannot discompose water and does not contribute to production of hydrogen. Thus, the water level sensor is preferably set to a water level at which the electrodes are not exposed from electrolyte 205.

For example, when all water produced by fuel cell 103 cannot be collected and part of the water is leaked to the outside of the system, a fluid level position of electrolyte 205 in solar hydrogen producing unit 101 decreases. When the water leaking to the outside reaches a certain level and the fluid surface of electrolyte 205 decreases to a set value of the water level sensor, the water level sensor sends a signal, and the control unit that receives the signal causes water supply unit 109 to introduce clean water.

At this time, the set value of the water level sensor is preferably set in consideration of a reduction rate of water through decomposition of water and a processing rate of water introduced from water supply unit 109 and purified by water purifier 105 such that the electrode unit is not exposed from electrolyte 205. An amount of introduced clean water may be set to a predetermined amount that is set in advance, or may be adjusted such that a fluid surface position of electrolyte 205 achieved when the amount of introduced water reaches a target amount is detected by arranging a second water level sensor and introduction of the clean water is stopped when the second water level sensor detects the fluid surface position. The water level sensor is preferably arranged at a position where the water level sensor does not prevent first electrode 203 serving as a photocatalytic semiconductor electrode from being irradiated with sunlight.

Furthermore, in solar hydrogen producing unit 101, a circulation path to circulate electrolyte 205 or a gas-liquid separator to separate hydrogen and oxygen produced through decomposition of water from moisture may be arranged.

The circulation path is arranged to smoothly remove generated hydrogen and oxygen from the electrode or to use solar heat acquired by solar hydrogen producing unit 101, and, depending on situations, a heat exchanger may be arranged on the circulation path. As one means that collects hydrogen produced by solar hydrogen producing unit 101, generated hydrogen is discharged to the outside of solar hydrogen producing unit 101 together with electrolyte 205 that is circulated and flows, and the hydrogen is separated from liquid in the connected gas-liquid separator and collected.

The water level sensor is arranged on the circulation path or in the gas-liquid separator. When the water level sensor is arranged on the circulation path, a place to measure a water level that fluctuates depending on an amount of water in solar hydrogen producing unit 101 may be specially set. The water level sensor is preferably set such that the water level sensor sends a signal before the electrode unit stored in solar hydrogen producing unit 101 is exposed from electrolyte 205 so as to introduce clean water from water supply unit 109.

As described above, the set value of the water level sensor is preferably set in consideration of a reduction rate of water through decomposition of water and a processing rate of water introduced from water supply unit 109 and purified by water purifier 105 such that the electrode unit is not exposed from electrolyte 205. Operations performed after the signal is sent to begin to introduce clean water are the same as those described above.

In the energy system in the embodiment, electric power is generated while rarely supplying external water. More specifically, electric power is generated by fuel cell 103 using hydrogen generated by solar hydrogen producing unit 101, and hydrogen is produced by solar hydrogen producing unit 101 using water produced by fuel cell 103. For example, it is assumed that an electric energy of about 15 kWh that is required per day is obtained by electric power generation performed by fuel cell 103. In this case, when solar hydrogen producing unit 101 has a capacity of decomposing about 5 liter of water per day, hydrogen to generate the electric energy can be supplied to fuel cell 103. Thus, the energy system can be operated without rarely supplying external water. For this reason, the sizes and efficiencies of water distribution mechanism 104 and solar hydrogen producing unit 101 are preferably set within a range in which the water can be decomposed and can be caused to flow in the system.

In the embodiment, water distribution mechanism 104 as described above has been described. However, water distribution mechanism 104 need only be configured to make it possible to distribute water produced by fuel cell 103 to solar hydrogen producing unit 101. Water purifier 105, water supply unit 109, first to third paths 106 to 108, and first to third pumps 110 to 112 may be arbitrarily selected and used as needed.

In particular, when water discharged from fuel cell 103 contains a small amount of impurity, water purifier 105 need not be daringly arranged between fuel cell 103 and solar hydrogen producing unit 101. FIG. 1B is a diagram showing another configuration of an energy system in the embodiment of the present invention. More specifically, water discharged from fuel cell 103 may be directly supplied to solar hydrogen producing unit 101 without passing through water purifier 105. With the above configuration, water distribution mechanism 104 can be more simplified, and a filter (for example, an ion-exchange resin cartridge) of water purifier 105 can be prevented from being deteriorated. Since pressure drop does not occur in water purifier 105, water can be supplied to solar hydrogen producing unit 101 with less energy. For this reason, a water supply capacity can be further increased.

A contact point, on the solar hydrogen producing unit 101 side, of second path 107 that connects water purifier 105 and solar hydrogen producing unit 101 to each other may be located on housing 201 that configures solar hydrogen producing unit 101 or may be located on an external circulation path when the electrolyte in solar hydrogen producing unit 101 is circulated in the external circulation path.

As described above, the energy system according to the embodiment includes solar hydrogen producing unit 101 that produces hydrogen through decomposition of water by a photocatalytic effect, fuel cell 103 that generates electricity by a reaction between the hydrogen produced by solar hydrogen producing unit 101 and an oxidizing gas and discharges water as a reaction product, and water distribution mechanism 104 that returns the water that is the reaction product discharged from the fuel cell to solar hydrogen producing unit 101. In this manner, by using hydrogen produced through decomposition of water in solar hydrogen producing unit 101 and external oxygen, electricity can be generated by fuel cell 103. Water produced by electric power generation in fuel cell 103 is collected and returned to solar hydrogen producing unit 101 by water distribution mechanism 104, so that the hydrogen can be produced by solar hydrogen producing unit 101 again using the water produced by the fuel cell. Thus, the energy system can be operated while suppressing an amount of external water supply to a low level.

Water distribution mechanism 104 includes water purifier 105 that purifies water discharged from the fuel cell. In this manner, since impurities contained in the water discharged from fuel cell 103 can be removed, water can be supplied to solar hydrogen producing unit 101 in a more preferable state. Thus, the efficiency of a water decomposition reaction in solar hydrogen producing unit 101 is improved, and the efficiency of the energy system can be improved. Since solar hydrogen producing unit 101 produces hydrogen by using water that contains an amount of impurity smaller than that of normal clean water and that is discharged from fuel cell 103, water purifier 105 can be configured by a water purifier having a purification capacity smaller than that of a water purifier to purify normal clean water. Thus, inexpensive water purifier 105 having a smaller size can be used. Heavy metal ions, halogen ions, and a material that blocks light from being transmitted are removed from water to make it possible to suppress deterioration of electrode unit 202 of solar hydrogen producing unit 101 and the system, to improve light transmittance, and to contribute to acceleration of a photocatalytic reaction. An amount of impurities contained in water (about 5 liters) generally discharged per day from fuel cell 103 is approximately ten-odd micrograms, and is very smaller than an amount of impurity (about 1 g) contained in an equal amount of general clean water.

Water distribution mechanism 104 further includes water supply unit 109 that receives water from the outside of the energy system. Water supplied from water supply unit 109 and water discharged from fuel cell 103 are purified by water purifier 105 and sent to solar hydrogen producing unit 101. In this manner, even if an amount of water in the energy system becomes a predetermined value or less, external water can be automatically supplied. For this reason, the energy system can be stably operated.

When the energy system according to the embodiment is normally operated, an amount of water circulated in the energy system is about 5 liters/day. Of the amount of water, an amount of water lost in the energy system is supposed to be up to about 270 ml/day. Thus, an amount of water that should be supplied from water supply unit 109 is up to about 270 mL/day. Thus, even though a general ion-exchange resin or the like is used, the ion-exchange resin can be supposed to be used for a long period of time, i.e., about 10 years. Thus, the energy system can be stably operated for a long period of time.

Fuel cell 103 has a stack, water distribution mechanism 104 sends part of water purified by water purifier 105 to fuel cell 103, removes heat generated by fuel cell 103, and humidifies the interior of the stack of fuel cell 103. In this manner, water purified by water purifier 105 can be used to cool fuel cell 103 and humidify the interior of the stack. Thus, water purifier 105 can be used to send water to solar hydrogen producing unit 101 and send water to fuel cell 103, and a reduction in number of parts and space saving can be achieved.

Water distribution mechanism 104 causes water purifier 105 to purify water left after the stack interior of fuel cell 103 is humidified and water that is a reaction product discharged from fuel cell 103. In this manner, water used to cool fuel cell 103 and humidify the stack interior can be purified and sent to solar hydrogen producing unit 101 and fuel cell 103 again. Thus, water balance is improved to make it possible to further improve the efficiency of the energy system.

Solar hydrogen producing unit 101 according to the embodiment is configured to have first electrode 203 having photocatalystic semiconductor layer 203B in housing 201. However, this configuration need not be necessarily used. For example, a configuration in which powder containing a photocatalytic semiconductor is dispersed in housing 201 may be used.

### First Modification

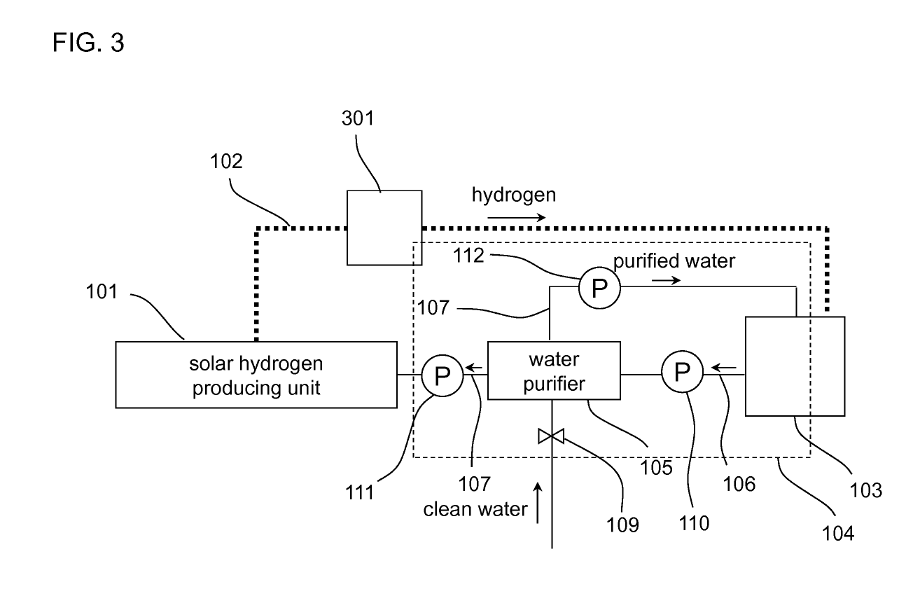

A first modification of the energy system according to the embodiment will be described below with reference to FIG. 3. The same reference numerals as in FIG. 1A denote the same constituent elements in FIG. 3, and a description thereof will be omitted. The following embodiment is just an example, and the present invention is not limited to the following embodiment.

FIG. 3 is a diagram showing a modification of the energy system according to the embodiment of the present invention. Hydrogen distribution mechanism 102 includes hydrogen storage equipment 301. Hydrogen storage equipment 301 stores hydrogen produced by solar hydrogen producing unit 101 and supplies the hydrogen to fuel cell 103. Hydrogen storage equipment 301 may be a vessel such as a tank or may be a means such as a hydrogen storing alloy of a storage type using a chemical method.

In production of hydrogen through decomposition of water using a photocatalytic semiconductor electrode, water can be decomposed only while the photocatalytic semiconductor electrode is irradiated with sunlight. More specifically, at night at which irradiation with sunlight is not performed or in poor weather conditions, hydrogen cannot be efficiently produced.

Hydrogen storage equipment 301 that can store hydrogen generated by solar hydrogen producing unit 101 is arranged to make it possible to store excessive hydrogen generated in a time zone in which irradiation with sunlight is performed in hydrogen storage equipment 301. In this manner, in a time zone in which irradiation with sunlight is not performed, by using hydrogen stored in hydrogen storage equipment 301, conversion to electric energy can be performed by fuel cell 103. For this reason, a stable energy system that is not dependent on time or weather can be achieved.

Hydrogen distribution mechanism 102 is provided with hydrogen storage equipment 301 and may be provided a compression device such as a compressor for a hydrogen gas to improve storage efficiency at an inlet portion of hydrogen storage equipment 301. On the upstream side of hydrogen storage equipment 301, a dehumidifier that removes moisture from hydrogen may be arranged.

### Second Modification

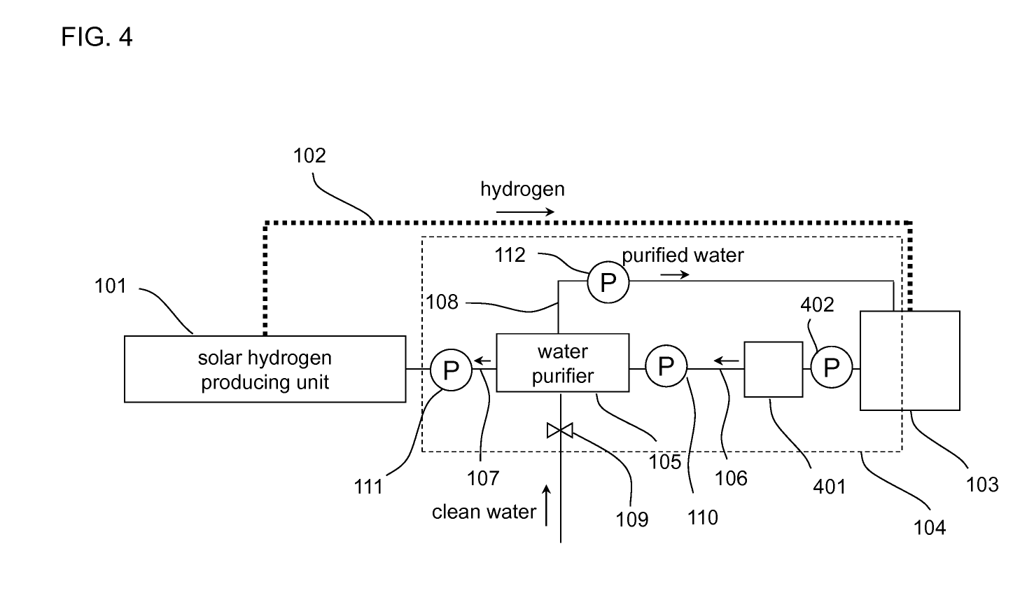

A second modification of the embodiment will be described below with reference to FIG. 4. The same reference numerals as in FIGS. 1A and 3 denote the same constituent elements in FIG. 4, and a description thereof will be omitted.

The following embodiment is just an example, and the present invention is not limited to the following embodiment.

FIG. 4 is a diagram showing a configuration of an energy system according to the embodiment of the present invention. In the energy system in the modification, water distribution mechanism 104 further includes water storage equipment 401. Water storage equipment 401 can temporarily store water that is a reaction product discharged from fuel cell 103. Water storage equipment 401, in water distribution mechanism 104, is arranged on first path 106 between the downstream side of the cathode chamber of fuel cell 103 and water purifier 105.

In the energy system, at night at which irradiation with sunlight is not performed or in a poor-weather time zone, solar hydrogen producing unit 101 cannot produce hydrogen through decomposition of water. Thus, since water does not decrease in solar hydrogen producing unit 101, water need not be supplied from water distribution mechanism 104.

On the other hand, fuel cell 103 may operate at night regardless of whether solar hydrogen producing unit 101 operates. In this case, water is produced in fuel cell 103 with a chemical reaction expressed by chemical formula (3) described in the embodiment, and cooling water or the like is discharged from fuel cell 103.

In the modification, water storage equipment 401 that stores water produced from fuel cell 103 and water used for cooling or the like of fuel cell 103 when fuel cell 103 operates when solar hydrogen producing unit 101 does not operate is arranged especially on first path 106 of water distribution mechanism 104. In this manner, even though fuel cell 103 operates in a state in which solar hydrogen producing unit 101 does not operate, water or the like produced from fuel cell 103 can be stored in water storage equipment 401. Thus, water stored in water storage equipment 401 when solar hydrogen producing unit 101 operates can be used, and water can be used without loss. Thus, the efficiency of the energy system can be further improved.

Water-jet pump 402 is arranged on first path 106 of water distribution mechanism 104. Water-jet pump 402 serves as a power source that collects water from fuel cell 103 and sends water to the water storage equipment 401.

Water stored in water storage equipment 401 is purified by water purifier 105 and supplied to solar hydrogen producing unit 101 and fuel cell 103 through second path 107 and third path 108.

At this time, water used to cool fuel cell 103, water used to humidify the stack of fuel cell 103, and water generated with a chemical reaction expressed by reaction formula (3) flow together with each other on first path 106 on the upstream side of water storage equipment 401 or in water storage equipment 401.

Also in the modification, as in the first modification, on hydrogen distribution mechanism 102, hydrogen storage equipment 301, a compressor, a dehumidifier, and the like may be arranged.

Although water storage equipment 401 is desirably arranged on first path 106, when water storage equipment 401 cannot be arranged because of space limitations, water storage equipment 401 may be arranged on second path 107. Water supply unit 109 may be connected to water storage equipment 401.

### Third Modification

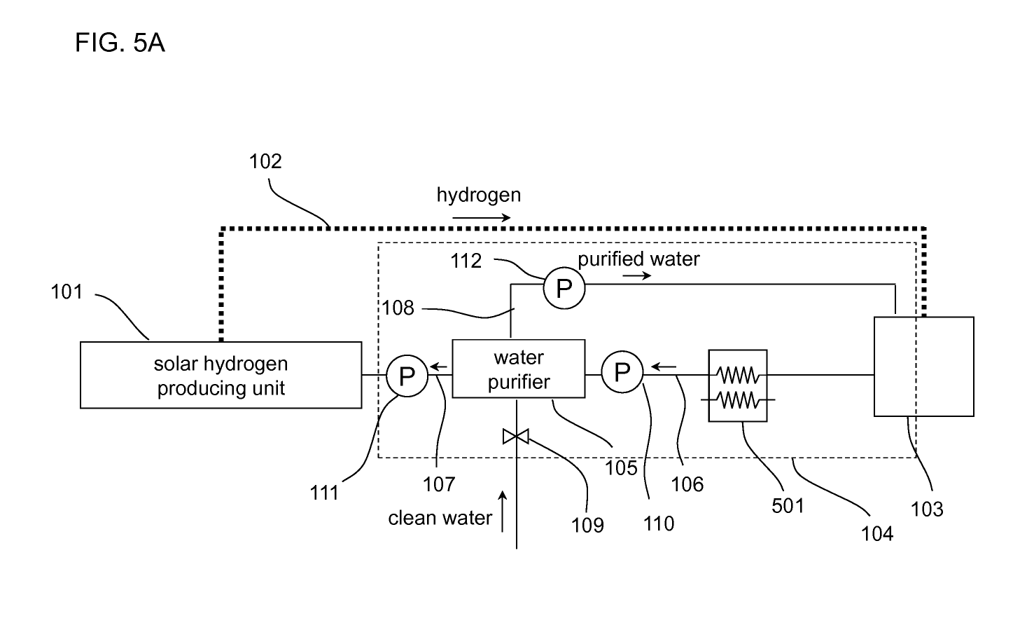

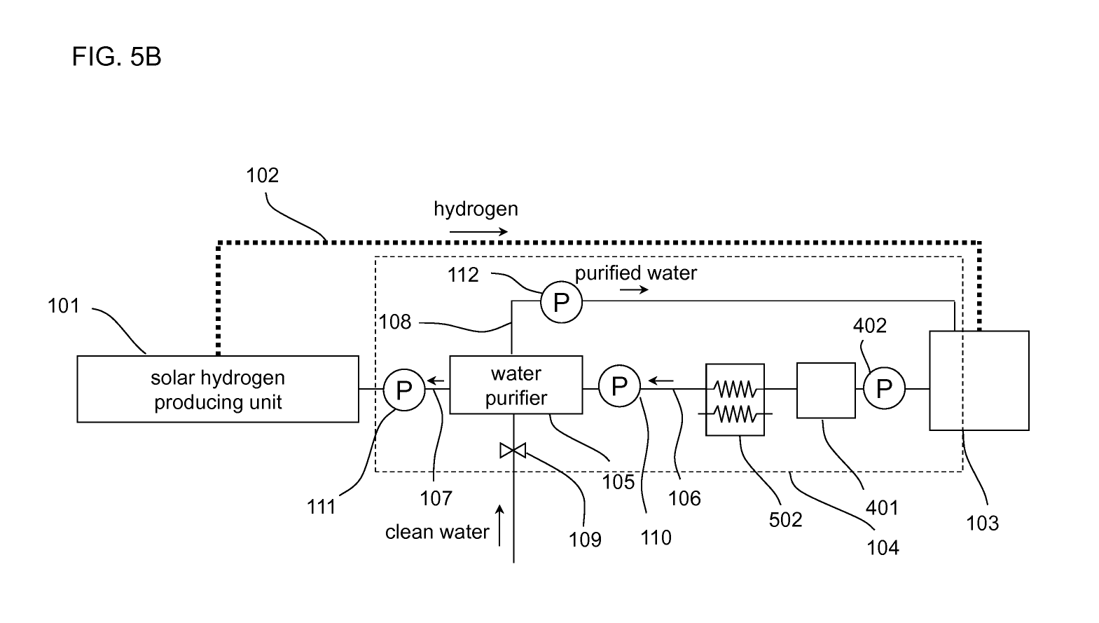

A third modification of the embodiment will be described below with reference to FIGS. 5A and 5B. The same reference numerals as in FIG. 1A and FIGS. 3 and 4 denote the same constituent elements in FIGS. 5A and 5B, and a description thereof will be omitted.

The following embodiment is just an example, and the present invention is not limited to the following embodiment.

FIGS. 5A and 5B are diagrams showing a modification of the energy system according to the embodiment of the present invention.

In FIG. 5A, on first path 106 in water distribution mechanism 104, first cooler 501 is arranged. First cooler 501 cools water that is a reaction product discharged from fuel cell 103.

Water discharged from fuel cell 103 is heated to a high temperature by heat generated in electric power generation by fuel cell 103. On the other hand, a bandgap of a photocatalytic semiconductor of first electrode 203 arranged in solar hydrogen producing unit 101 shrinks in a high-temperature environment, and water decomposition efficiency is deteriorated such that an overvoltage required for decomposition of water cannot be obtained.

When high-temperature water discharged from fuel cell 103 is cooled by first cooler 501 and supplied to solar hydrogen producing unit 101, a temperature in solar hydrogen producing unit 101 can be suppressed from increasing, and the water decomposition efficiency can be prevented from being deteriorated.

At this time, water used to cool fuel cell 103, water used to humidify the stack of fuel cell 103, and water generated with a chemical reaction expressed by reaction equation (3) flow together with each other on the upstream side of first cooler 501, for example on first path 106. First pump 110 may be arranged on the upstream side of first cooler 501 or may be arranged on the downstream side thereof.

In FIG. 5B, as in the second modification on first path 106, a structure including water storage equipment 401 and water-jet pump 402 is used. Furthermore, water distribution mechanism 104 has second cooler 502. Second cooler 502 cools water flowing out of water storage equipment 401. Second cooler 502 is arranged on the downstream side of water storage equipment 401 on first path 106.

When water is stored at ambient temperatures in water storage equipment 401, bacteria and the like may glow and contaminate the entire system including water purifier 105 and the like. Thus, water discharged from fuel cell 103 is preferably stored in water storage equipment 401 in a state of a high temperature of at least about 60° C. or more. Thus, the water sent from water storage equipment 401 basically has a high temperature of about 60° C. When the water is directly used, as described above, water decomposition efficiency or the like is deteriorated.

Water flowing out of water storage equipment 401 is cooled by second cooler 502 and used to make it possible to suppress a temperature of solar hydrogen producing unit 101 from increasing and to prevent water decomposition efficiency from being deteriorated.

First cooler 501 and second cooler 502 are preferably configured by heat exchangers. Heat energy collected in first cooler 501 and second cooler 502 may be used for warm water, a heater, or the like.

Also in the modification, as in the first modification, on hydrogen distribution mechanism 102, hydrogen storage equipment 301, a compressor, a dehumidifier, and the like may be arranged.

A heat radiator may be arranged in place of first cooler 501 and second cooler 502 to cool water discharged from fuel cell 103.

### Fourth Modification

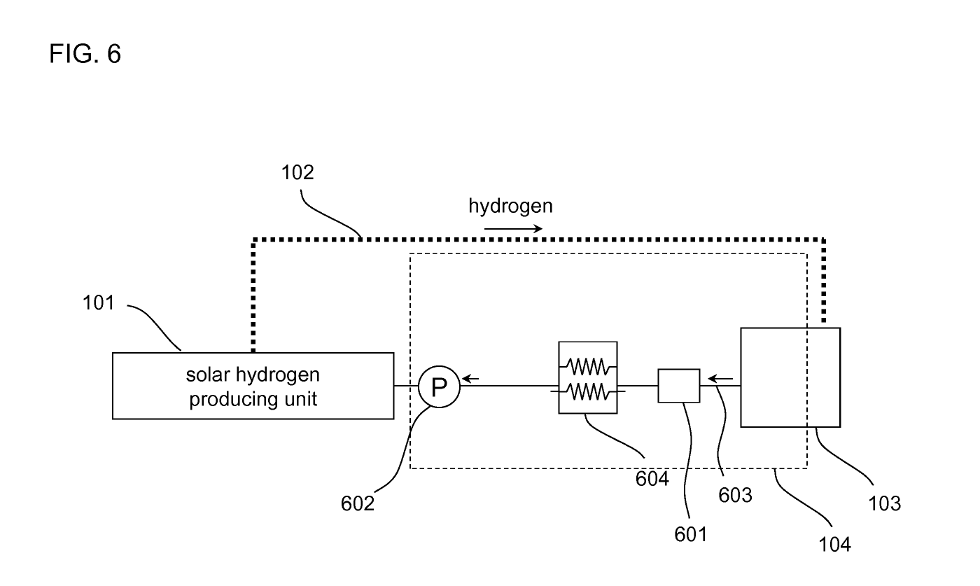

A fourth modification of the embodiment will be described below with reference to FIG. 6. The same reference numerals as in FIG. 1A and FIGS. 3 to 5 denote the same constituent elements in FIG. 6, and a description thereof will be omitted.

The following embodiment is just an example, and the present invention is not limited to the following embodiment.

FIG. 6 is a diagram showing a modification of the energy system in the embodiment of the present invention. In the modification, fuel cell 103 is especially a fuel cell of an SOFC (Solid Oxide Fuel Cell) type. A condenser 601 is arranged on path 603 of water distribution mechanism 104. Condenser 601 condenses high-temperature water vapor discharged from fuel cell 103. Furthermore, water distribution mechanism 104 includes third cooler 604 on the downstream side of condenser 601. Third cooler 604 cools high-temperature water flowing out of condenser 601. The cooled water is pressured by pump 602 and sent to solar hydrogen producing unit 101.

The SOFC-type fuel cell is driven at a temperature of about 400 to 1000 degrees centigrade that is higher than that of a general PEFC-type fuel cell. Thus, a gas containing high-temperature water vapor is discharged from the anode side of the fuel cell by electric power generation. The water vapor contained in the gas rarely contains heavy metals, halogen ions, and the like that are impurities contained in water discharged from a general fuel cell.

Thus, when the water vapor is condensed, the energy system in the modification can supply water containing less impurities to solar hydrogen producing unit 101 without arranging water purifier 105. Thus, the configuration of the energy system can be simplified, and the efficiency of the system can be improved.

As a matter of course, a configuration using water purifier 105 may be used. Water purifier 105 is arranged to make it possible to supply water having less impurities to solar hydrogen producing unit 101.

In this modification, the configurations described in the embodiments can be arbitrarily arranged. As in the first modification, on hydrogen distribution mechanism 102, hydrogen storage equipment 301, a compressor, a dehumidifier, and the like may be arranged.

### INDUSTRIAL APPLICABILITY

The energy system according to the present invention collects water generated by a fuel cell, purifies the water, recycles the water in a solar hydrogen producing unit, and causes a fuel cell to generate electricity by using hydrogen produced by the solar hydrogen producing unit. In this manner, an energy system that can generate electricity while rarely supplying external water supply and is independent in terms of water resources is established. The present invention is useful for an energy system using a fuel cell.

### REFERENCE MARKS IN THE DRAWINGS

101 solar hydrogen producing unit
102 hydrogen distribution mechanism
103 fuel cell
104 water distribution mechanism
105 water purifier
106 first path
107 second path
108 third path
109 water supply unit
110 first pump
111 second pump
112 third pump
201 housing
202 electrode unit
203 first electrode
203A conductive substrate
203B photocatalytic semiconductor layer
204 second electrode
205 electrolyte
206 ion-exchange membrane
301 hydrogen storage equipment
401 water storage equipment
402 water-jet pump
501 first cooler
502 second cooler
601 condenser
602 pump
603 path
604 third cooler

1. An energy system comprising:
a solar hydrogen producing unit that produces hydrogen through decomposition of water by a photocatalytic function;
a fuel cell that generates electricity with a reaction between the hydrogen generated by the solar hydrogen producing unit and an oxidizing gas and discharges water as a reaction product; and
a water distribution mechanism that returns water serving as the reaction product discharged from the fuel cell to the solar hydrogen producing unit,
wherein the water distribution mechanism includes a water purifier that purifies water discharged from the fuel cell and a water supply unit that receives external water, causes the water purifier to purify water supplied from the water supply unit and water discharged from the fuel cell, and sends the purified water to the solar hydrogen producing unit.

2-3. (canceled)

4. The energy system according to claim 1, wherein
the solar hydrogen producing unit includes a water level sensor that detects an internal water level,
the water level sensor sends a signal to a control unit when the water level decreases to a set value set in advance, and
the control unit causes the water supply unit to supply a predetermined amount of conducting water to the solar hydrogen producing unit upon receiving the signal.

5. The energy system according to claim 4, wherein the set value is set to a water level at which an electrode unit of the solar hydrogen producing unit is not exposed from an electrolyte.

6. The energy system according to claim 4, wherein the solar hydrogen producing unit further includes a circulation path to circulate the electrolyte or a gas-liquid separator to separate hydrogen and oxygen produced through decomposition of water from moisture.

7. The energy system according to claim 6, wherein the water level sensor is arranged on the circulation path or the gas-liquid separator.

8. The energy system according to claim 1, wherein
the fuel cell has a stack, and
the water distribution mechanism sends part of water purified by the water purifier to the fuel cell, removes heat generated by the fuel cell, and humidifies an interior of the stack of the fuel cell.

9. The energy system according to claim 8, wherein the water distribution mechanism causes the water purifier to purify water remaining after the interior of the stack of the fuel cell is humidified and water serving as a reaction product discharged from the fuel cell.

10. The energy system according to claim 1, wherein the solar hydrogen producing unit includes a first electrode containing a semiconductor material that decomposes water into hydrogen and oxygen, a second electrode electrically connected to the first electrode, and a housing that retains an electrolyte containing at least water.

11. The energy system according to claim 1, further comprising hydrogen storage equipment that stores hydrogen produced by the solar hydrogen producing unit and supplies the hydrogen to the fuel cell.

12. The energy system according to claim 1, wherein the water distribution mechanism includes water storage equipment that temporarily stores water serving as a reaction product discharged from the fuel cell.

13. The energy system according to claim 12, wherein the water distribution mechanism has a first cooler that cools water flowing out of the water storage equipment.

14. The energy system according to claim 13, wherein the first cooler is a heat exchanger.

15. The energy system according to claim 1, wherein the water distribution mechanism includes a second cooler that cools water serving as a reaction product discharged from the fuel cell.

16. The energy system according to claim 15, wherein the second cooler is a heat exchanger.
